(19) United States
(12) Patent Application Publication
(10) Pub. No.: US 2022/0089078 A1
(43) Pub. Date: Mar. 24, 2022

(54) MOTOR VEHICLE FLOOR COVERING, BOOT OR TRUNK COVERING OR LOAD COMPARTMENT COVERING HAVING A STRUCTURALLY NEEDLE-PUNCHED CARPET SURFACE (II)

(71) Applicant: ADLER PELZER HOLDING GMBH, Hagen (DE)

(72) Inventors: Frank FALK, Albstadt (DE); Volkmar SCHULZE, Schierling (DE)

(73) Assignee: ADLER PELZER HOLDING GMBH, Hagen (DE)

(21) Appl. No.: 17/423,418

(22) PCT Filed: Jan. 9, 2020
(86) PCT No.: PCT/EP2020/050381

§ 371 Date: Jul. 15, 2021

(30) Foreign Application Priority Data
Jan. 15, 2019 (DE) 10 2019 100 919.7

(51) Int. Cl. B60N 3/04; D04H 11/08; D04H 18/02

(52) U.S. Cl. CPC B60N 3/042; B60N 3/048; D04H 18/02; D04H 11/08

(57) ABSTRACT

The subject matter of the invention is a method for producing a three-dimensionally shaped floor panelling, luggage compartment panelling or load floor panelling for motor vehicles, the carpet surface of which has a needled structure on the visible side, as well as the panelling itself.

The object of the invention is a method of manufacturing a three-dimensionally shaped floor panelling, luggage compartment panelling or load floor panelling for motor vehicles, the carpet surface of which has a needled structure on the visible side, as well as the panelling itself.

The surface material for a motor vehicle itself is a velour carpet, which may have several sub-layers as well as foam or fibre/fleece insulation towards the body.

Especially due to the development of e-vehicles, design/styling is looking for alternative solutions in the deformable carpet surface, compared to plain, smooth flat needlepunch, velour and tufted carpet.

In the case of motor vehicles with rear doors (station wagons) and fold-down rear seat backs, this styling also applies in particular to the luggage compartment, since when the rear door is open and the rear seat backs are folded down, one looks from the rear into the interior of the motor vehicle which is thus exposed. Both the luggage compartment and the passenger compartment must then embody a uniform, coherent styling.

In the state of the art, various designs of carpet uppers for motor vehicle floor panelling as well as luggage compartment panelling and load floor panelling are known, namely in particular tufted, velour and flat needlefelt carpets.

For tufted carpets, PA6.6, PA6, PP, rPA and PET, rPET as well as the corresponding bio-based polyamides (PA 5.10; PA 6.10) are used in particular; and for the velour and flat needlepunch carpets, PET, PET/PP, PP, PA/PET and rPET are mainly used as yarn/fibre material.

In the prior art, processes for the production of velour carpets are known, see among others DE 44 09 771 A1, DE 29 00 935 C2 and DE 10 2008 026 968 A1.

A velour fleece is a refined needle fleece in which a fibre pile has been created in a prefabricated fleece material by means of needling in a running homogeneous brush belt. If this is then sheared to a defined pile height, it is referred to as a sheared velour.

A velour carpet differs from a needlepunch carpet in that it has a higher-quality look and feel, as well as improved wear behaviour.

For homogenisation of the stitch pattern in a needlepunched nonwoven, special processes are described in U.S. Pat. No. 9,567,698 B2, US 2016/0069006 A1, US 9 260 806 B2, US 2015/0259836 A1 and EP 2 918 719 A1. In the production of a flat needle-punched nonwoven, staple fibres are consolidated after nonwoven formation by means of carding and crosslapping via multiple needling between two metal plates. In a further work step, by means of repeated needling in a brush belt, a velour needle fleece can be produced from this flat needle fleece. For both variants, it is necessary to thermally or chemically bond the staple bevels after needling to achieve good final strength.

The fibres are mostly incorporated by means of foamed La tex or acrylate. A combined use of latex or acrylate and BiCo fibre (coPET/PET bicomponent fibre) is also common in practice. Furthermore, the integration is also realised exclusively via BiCo fibre.

WO 2017/061970 A1 specifically deals with the binding of the carpet using bicomponent (BiCo) fibres. Here, the optimisation of the (BiCo) fibre fixation by using special slot nozzles in the drying oven is described. In addition, the following are known: scattered PE, EVA/PE mixture, extruded PE, films, hot glue, thermoplastic dispersions and thermobonding (EP 1 598 476 B1).

DE 2 008 439 C [U.S. Pat. No. 3,755,055] describes a process in which a monochrome or melanged nonwoven web and a nonwoven web printed on one side with pigment dyes with an ornamental pattern in one or more colours are laid on top of one another, wherein the printed side of one nonwoven web facing the unprinted side of the other nonwoven web, and then both nonwoven webs are needled through from the unprinted surface to such an extent that the fibres of the unprinted nonwoven web mix with the fibres of the printed nonwoven web to form a pile on its printed surface and its printed ornamental pattern is changed to a soft and three-dimensional pattern.

DE 39 04 526 A1 discloses a floor covering and a method for its production. For the production of a floor covering consisting of two layers of needle-punched nonwoven, of which the top layer is structured on its upper side, the under layer is needled into the structured top layer from the underside. The depth of the needling is much less than the thickness of the top layer. By needling the two layers together from the back of the top layer, the structure of this top layer is not destroyed. After needling, the two layers are additionally joined by impregnating them with a bonding agent through the top layer.

In EP 0 888 743 A1 [US 2002/0029445 A1, U.S. Pat. Nos. 6,287,407 B1, US 6.398.895 B1], a structured textile material made of at least two different base webs for the field of cleaning textiles is described. The technical teaching relates to a structured textile material made of at least two different needled base nonwovens, wherein the base nonwovens have a structure obtained by needling from at least one side, wherein the needles used for structure needling are fork or crown needles and the depth of the forks or the beards, respectively, is selected such that they are completely filled with fibres of the base nonwoven facing the needles when the needles are pierced, and wherein the textile material has unmixed, pure fibres in the pattern, in the base and on the reverse side. In the method for producing the structured textile material, it is stated, on the one hand, that a lamination of the two needled base nonwovens having melt fibres is carried out without activating the melt fibres, that a one-sided or two-sided structure needling is then carried out, and that the melt fibres of the base nonwovens are activated after the structure needling; and, on the other hand, in that, before entry into a structural needling machine, an intermediate layer of a material capable of bonding the two base nonwovens, in particular an adhesive nonwoven, is introduced between the two needled base nonwovens having melt fibres, in that the two base nonwovens and the intermediate layer are subjected together to one-sided or two-sided structural needling, and in that the bond between the two base nonwovens and the intermediate layer is then produced by activating the melt fibres and the intermediate layer.

WO 2011/045691 A1 describes a graphic velour carpet and its production. Two structuring machines, each equipped with 2 needle boards, and a base and a top nonwoven are used. The base nonwoven is fed onto the top nonwoven between the two structuring machines and needled into a nonwoven in the second structuring machine. The needles in the needle boards are arranged in predetermined patterns. An adhesive is applied to the base nonwoven, which then fixes/bonds the fibres of the nonwoven layers.

Furthermore, it is known to create patterns in a needlefelt web by means of several components, fibre layers and several needling processes, see among others DE 103 46 473 A1 and WO 2011/065851 A1.

DE 20 2009 000 775 U1 describes a fibre surface structure consisting of a needled nonwoven or fibre pile (surface layer) on the visible side and a fibre pile or fibre nonwoven (pattern layer), which are joined together by needling by means of different needle types and/or needle arrangements and/or stitching directions and/or stitching depths. The pattern layer is pre-processed, the pattern layer differs from the surface layer in the fibres themselves and the fibre colouring; also, the pattern layer has been punched out and/or cut out before needling with the surface layer; and is dyed and/or printed. Furthermore, several different sample piles or sample nonwovens are used as the sample layer. The surface layer is back-needled and surface-treated.

All “structure-needled” applications, processes and devices as well as material structures described in the prior art concern non-(single-layer) flat needle-punched nonwoven or velour carpets for use in motor vehicles, their three-dimensional deformation into motor vehicle floor panelling, luggage compartment panelling or load floor panelling. There is no report of a non-destructive structure that retains its surface structure in a durable manner during three-dimensional deformation in the contact heating field (laminating press), radiant heating field and in the deformation tool itself.

The object of the present invention in comparison with the aforementioned prior art is thus to provide a structurally needled carpet which is suitable for deformation and which upgrades the passenger compartment and/or luggage compartment and/or load compartment of motor vehicles to the effect that the latter has a “living room/well-being atmosphere”. In particular, it is an object of the invention, during the manufacture of velour carpet or the velourisation of needlepunchend nonwoven carpet, to introduce a permanent, hard-wearing surface pattern with a possibly three-dimensional structure, which is structured differently over the width of the carpet surface and withstands three-dimensional deformation to form a motor vehicle floor or luggage compartment panelling.

In a first embodiment, the subject matter of the present invention is a method for producing a three-dimensionally deformable velour carpet for a floor panelling, a luggage compartment panelling or a load floor panelling of a motor vehicle with a structurally needled, deformation-resistant surface having a grammage of the carpet in the range from 300 g/m2 to 700 g/m2, which is characterized in that two or more needle types of different lengths are arranged in segments across the width of a needle board, with a defined setting of the penetration depth as well as a defined setting of the penetration density, the structured velour carpet from an initial nonwoven is produced by needling, and the velour carpet is provided and deformed with one or more underlayers.

The core of the present invention is thus the provision of a velour carpet for a floor panelling, a luggage compartment panelling or a loading floor panelling of a motor vehicle, produced in a conventional standard process, with a structurally needle-punched, deformation-resistant visible surface, solely by the arrangement of needle types of different lengths across the width of the needle board and/or the needle boards which are used for needle-punching or velouring the carpet for a floor panelling, a luggage compartment panelling or a loading floor panelling of a motor vehicle. The needle boards are equipped across the width with predefined needle types/geometries, namely the needle lengths, which thus create a predefined, possibly three-dimensional structure of the velour surface. In a particularly preferred embodiment, needle types are used in segments, which can differ not only in length but also in other parameters, such as fineness, fork opening and fork orientation.

The advantage of the present invention is to provide a deformation-resistant/stable, structurally needled velour carpet for the production of motor vehicle floor panelling, luggage compartment panelling or load floor panelling without an additional work step in its production compared to standard velour carpet production.

The method of the present invention can be implemented -without additional nonwoven layers, needling stages, needling machines or needle boards-in “standard” systems solely by the needle geometry/needle type, the needle length of the needles arranged across the width of the needle board.

A further embodiment of the present invention consists in a three-dimensionally shaped velour carpet for a floor panelling, a luggage compartment panelling or a load floor panelling of a motor vehicle with a structurally needled, deformation-resistant surface with a grammage of the carpet in the range from 300 g/m2 to 700 g/m2, further comprising one or more underlayers, wherein the visible side of the velour carpet has a structurally needled, hard-wearing surface.

The realisation is to take place on the one hand with a single-layer and on the other hand with a two-layer velour carpet. In the case of a two-layer version, additional colour effects with different structures can be needled in.

Example of execution:

For the production of a deformation-resistant/stable, structurally needled velour carpet, a pre-nonwoven of a fibre mix consisting of 60% commercially available 12 dtex fibres, fibre length 60 mm, 30% commercially available 17 dtex fibres, fibre length 69 mm and 10% commercially available 4.4 dtex fibres, fibre length 51 mm (BiCo) was used as the initial nonwoven. The basis weight was 615 g/m2.

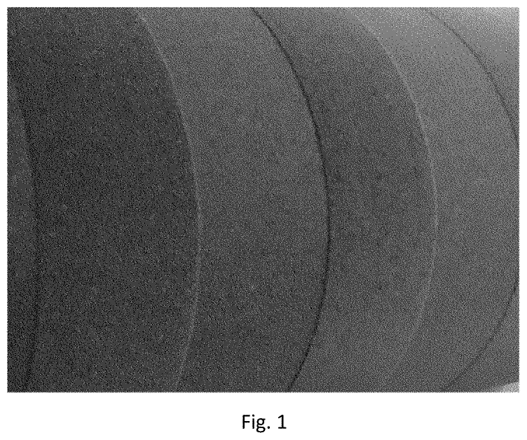

The different length fork needles from Groz-Beckert KG 15X16X20X40X73,0 D G 9077/616751 [length: 74.8 mm] and 15X17X32X40X74,8 D G 9077 15921 [length: 76.6 mm] have been installed in a needle board of the Velours IV (8000 n/lm), alternating in 20 cm wide strips. The zero balance of the machine was adjusted to the longer of the two needles. During production, it was important to find the optimum penetration depth and the optimum penetration density by testing the machine settings. For the velour carpet shown in FIG. 1, the stitch density was 650 st/cm2 and the stitch depth was 5 mm.

The structural needled velour carpet produced in this way was then bound with 80 g/m2 latex; and coated with 80 g/m2 PE. Subsequently, the velour carpet was formed with a 150 g/m2 nonwoven film into a floor covering upper material of a mid-range vehicle at the process parameters contact heating field 170° C., 58 sec; radiant heating field 140° C. and a mould closing time of 66 sec at the mould surface temperature of 7° C.

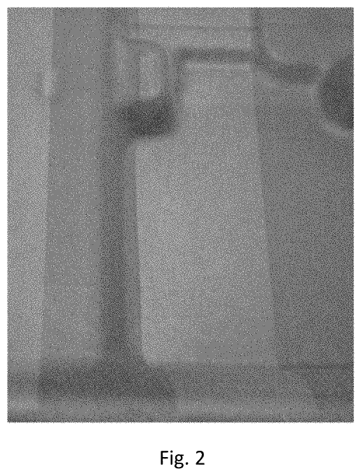

FIG. 2 shows a section of the deformed floor covering upper material. The structuring can be clearly seen. Especially in FIG. 2, it can be seen that the structural needling of the carpet is deformation-appropriate and deformation-stable.

1. A method for the production of a three-dimensionally deformable velour carpet for a floor panelling, a luggage compartment panelling or a load floor panelling of a motor vehicle with a structurally needled, deformation-resistant surface having a grammage of the carpet in the range from 300 g/m2 to 700 g/m2, characterised in that two or more needle types of different lengths are arranged in segments across the width of a needle board, with a defined setting of the penetration depth as well as a defined setting of the penetration density, the structured velour carpet is produced from an initial nonwoven by needling, and the velour carpet is provided and deformed with one or more underlayers.

2. Method according to claim 1, characterised in that needles are used which differ in length, fineness, fork opening and/or fork orientation.

3. Three-dimensionally shaped velour carpet for a floor panelling, a luggage compartment panelling or a loading floor panelling of a motor vehicle with a structurally needled, deformation-resistant surface with a grammage of the carpet in the range from 300 g/m2 to 700 g/m2, further comprising one or more underlayers, characterised in that the visible side of the velour carpet has a structurally needled, hard-wearing surface.
